(19) United States
(12) Patent Application Publication
(10) Pub. No.: US 2026/0094428 A1
(43) Pub. Date: Apr. 2, 2026

(54) PERFORMING PERCEPTION TASKS BY LEVERAGING AUTO-REGRESSIVE NEURAL NETWORKS

(71) Applicant: Waymo LLC, Mountain View, CA (US)

(72) Inventors: Alex Zihao Zhu, Mountain View, CA (US); Hao Xiang, Sunnyvale, CA (US); Zhaoqi Leng, Milpitas, CA (US); Mingxing Tan, Newark, CA (US); Dragomir Anguelov, San Francisco, CA (US)

(21) Appl. No.: 19/348,113

(22) Filed: Oct. 2, 2025

Related U.S. Application Data
(60) Provisional application No. 63/702,575, filed on Oct. 2, 2024.

(51) Int. Cl. G06V 10/82; G06V 10/26; G06V 10/40; G06V 20/56

(52) U.S. Cl. CPC G06V 10/82; G06V 10/40; G06V 20/56; G06V 10/26

(57) ABSTRACT

Methods, systems, and apparatus, including computer programs encoded on a computer storage medium, for performing perception tasks on received sensor data. The method includes obtaining one or more query images and a plurality of context images; generating a sequence of discrete tokens representing the context images; generating one or more continuous tokens representing the one or more query images; processing an input comprising the sequence of discrete tokens representing the context images and the one or more continuous tokens representing the one or more query images using a token processing neural network to generate one or more updated continuous tokens representing the one or more query images; and processing the one or more updated continuous tokens to generate a respective output for each of one or more prediction tasks.

### CROSS-REFERENCE TO RELATED APPLICATION

This application claims priority to U.S. Provisional Application No. 63/702,575, filed on Oct. 2, 2024. The disclosure of the prior applications is considered part of and is incorporated by reference in the disclosure of this application.

### BACKGROUND

This specification relates to processing data using a neural network, e.g., a neural network deployed on-board an autonomous vehicle.

Autonomous vehicles include self-driving cars, boats, and aircraft.

Autonomous vehicles use a variety of on-board sensors and computer systems to detect nearby objects and use such detections to make control and navigation decisions, e.g., by predicting the future trajectories of agents in the vicinity of the autonomous vehicles using the detections.

### BRIEF DESCRIPTION OF THE DRAWINGS

FIG. 1 is a block diagram of an example system.

FIG. 2 is a block diagram of an example perception inference system.

FIG. 3 is a block diagram of another example perception training system.

FIG. 4 is a flow diagram of an example process for performing perception tasks on received sensor data.

Like reference numbers and designations in the various drawings indicate like elements.

### DETAILED DESCRIPTION

This specification describes a system implemented as computer programs on one or more computers in one or more locations that performs perception tasks on received sensor data.

Performing accurate perception in autonomous driving is a complex challenge because it requires not only interpreting the current scene, but also reasoning over temporal context and multiple sensing modalities. For example, an autonomous vehicle can approach an intersection where other vehicles are turning, pedestrians are entering crosswalks, and visual elements such as signs or lane markings are partially occluded. Conventional perception systems process each frame in isolation or rely solely on continuous feature embeddings, which limits their ability to leverage long-term temporal cues and high-level world knowledge. Moreover, prior token-based auto-regressive models have focused primarily on visual generation quality and often lose important geometric information due to errors introduced during tokenization, which results in the models being poorly suited for fine-grained perception tasks, such as depth estimation or semantic segmentation.

In contrast, the described system leverages both discrete representations and continuous representations of received sensor data for performing one or more perception tasks. In particular, the system can convert a sequence of context images from prior time steps into discrete tokens from a fixed vocabulary, and the system can represent current query images as one or more continuous tokens that represent spatial and semantic detail. The system can use an auto-regressive neural network, such as a transformer with causal self-attention, to process both the discrete context tokens and the continuous query tokens to generate updated continuous query tokens. The system can then process the updated continuous query tokens to generate outputs for different perception prediction tasks, including object detection, semantic segmentation, depth estimation, optical flow prediction, and other scene understanding functions. By combining discrete world simulation with continuous perception, the system provides a scalable framework for vision-based autonomous driving. As such, the described system represents a significant improvement over existing token-only or feature-only models, enabling more accurate, robust, and generalizable perception for both real-world deployment and simulation-based testing.

Additionally, unlike conventional approaches that rely on either discrete tokens alone or continuous embeddings alone, the system can leverage an encoder adapter and a decoder adapter to fuse the two representations, which allows for temporal and scene context information to guide dense per-pixel predictions. Thus, this hybrid representation enables the system to capture long-range dependencies across frames while maintaining the precision required for detailed perception tasks.

Advantageously, the system can be deployed in multiple contexts. In a real-world autonomous vehicle, the predictions may be used directly by the vehicle's control system to inform motion planning and navigation in dynamic environments. In a simulation environment, the system can generate predictions to evaluate the realism of virtual driving scenarios, to train downstream models, or to test software against complex interactions not easily captured in logged datasets.

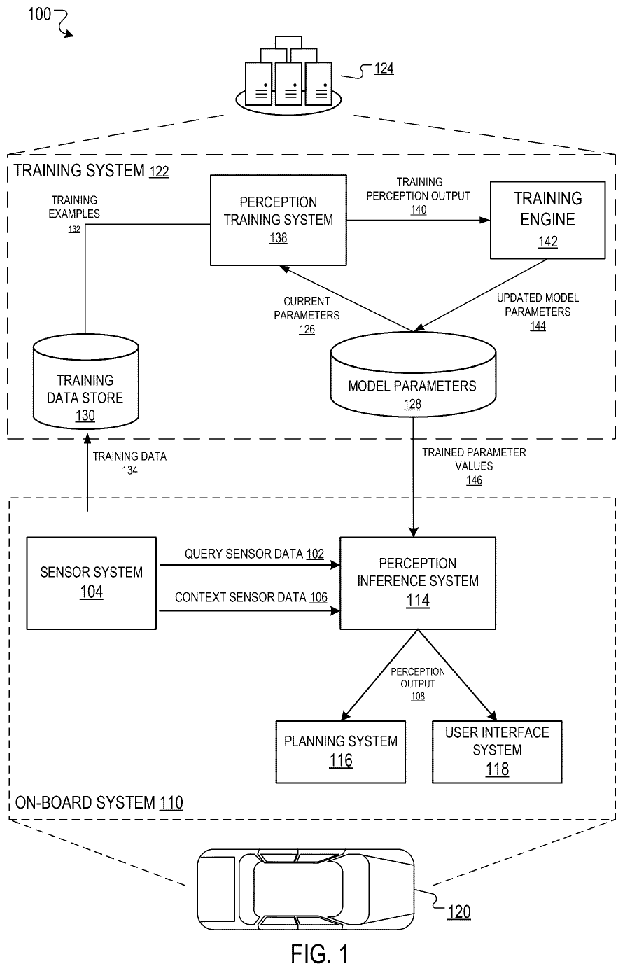

FIG. 1 is a diagram of an example system 100. The system 100 includes an on-board system 110 and a training system 122.

The on-board system 110 is located on-board a vehicle 120. The vehicle 120 in FIG. 1 is illustrated as an automobile, but the on-board system 110 can be located on-board any appropriate vehicle type.

In some cases, the vehicle 120 is an autonomous vehicle. An autonomous vehicle can be a fully autonomous vehicle that determines and executes fully-autonomous driving decisions in order to navigate through an environment. An autonomous vehicle can also be a semi-autonomous vehicle that uses predictions to aid a human driver. For example, the vehicle 120 can autonomously apply the brakes if a prediction indicates that a human driver is about to collide with another vehicle. As another example, the vehicle 120 can have an advanced driver assistance system (ADAS) that assists a human driver of the vehicle 120 in driving the vehicle 120 by detecting potentially unsafe situations and alerting the human driver or otherwise responding to the unsafe situation. As a particular example, the vehicle 120 can alert the driver of the vehicle 120 or take an autonomous driving action when an obstacle is detected, when the vehicle departs from a driving lane, or when an object is detected in a blind spot of the human driver.

The on-board system 110 includes a sensor system 104 which enables the on-board system 110 to “see” the environment in the vicinity of the vehicle 120. More specifically, the sensor system 104 includes one or more sensors, some of which are configured to receive reflections of electromagnetic radiation from the environment in the vicinity of the vehicle 120. For example, the sensor system 104 can include one or more laser sensors (e.g., lidar laser sensors) that are configured to detect reflections of laser light. That is, the lidar laser sensors can collect data in the form of point clouds, where each point of the point cloud represents a feature of the environment at a particular time point. As another example, the sensor system 104 can include one or more radar sensors that are configured to detect reflections of radio waves. As another example, the sensor system 104 can include one or more camera sensors that are configured to detect reflections of visible light. That is, a camera sensor can capture one or more camera images at different time points.

The sensor system 104 continually (i.e., at each of multiple time points) captures raw sensor data, which can indicate the directions, intensities, and distances travelled by reflected radiation. For example, a sensor in the sensor system 104 can transmit one or more pulses of electromagnetic radiation in a particular direction and can measure the intensity of any reflections as well as the time that the reflection was received. A distance can be computed by determining the time which elapses between transmitting a pulse and receiving its reflection. Each sensor can continually sweep a particular space in angle, azimuth, or both. Sweeping in azimuth, for example, can allow a sensor to detect multiple objects along the same line of sight.

The on-board system 110 can process the raw sensor data to generate query sensor data 102 and context sensor data 106. For example, the query sensor data 102 can have been captured by a set of one or more sensors of the sensor system 104 at a current time point, and the context sensor data 106 can include sensor data captured by the one or more sensors of the sensor system 104 at each of one or more preceding time points. In some examples, rather than retaining the full raw sensor data for the one or more preceding time points, the on-board system 110 can process the raw sensor data at the one or more preceding time points to generate and store a representation of the context sensor data 106 (e.g., discrete tokens or structured outputs), which the on-board system 110 can then use in place of or in addition to the raw context sensor data for performing perception tasks.

Generally, the query sensor data 102 can include one or more query images, and the context sensor data 106 can include a sequence of context images captured by one or more camera sensors of the sensor system 104. In some examples, the query sensor data 102 can include query radar data, and the context sensor data 106 can include context radar data captured by one or more radar sensors. In some examples, the query sensor data 102 can include one or more query range images or point clouds, and the context sensor data 106 can include one or more context range images or point clouds captured by one or more laser sensors, e.g., Lidar sensors.

As yet another example, the query sensor data 102 and context sensor data 106 can both include sensor data from multiple different types of sensors, e.g., both camera sensor data and Lidar sensor data.

At any given time point, the on-board system 110 can process the query sensor data 102 and the context sensor data 106 using a perception inference system 114 to generate a perception output 108 for one or more perception tasks.

In particular, the perception inference system 114 can generate a sequence of discrete context tokens representing the context images of the context sensor data 106 and continuous query tokens representing the query images of the query sensor data 102. In some examples, the perception inference system 114 can store the generated discrete context tokens (or other representations, such as structured outputs from task neural networks (e.g., depth maps, segmentation maps, edge maps, etc.)), and the perception inference system 114 can discard the underlying raw context sensor data, thus avoiding the need to regenerate the discrete context tokens for subsequent processing.

The perception inference system 114 can then update the continuous query tokens using a token processing neural network by leveraging the discrete context tokens as temporal context, scene context, or both. After updating the continuous query tokens, the perception inference system 114 can process the updated continuous tokens to generate respective perception outputs 108 for a particular perception task, such as depth maps, semantic segmentation masks, object detections, optical flow estimates, or other scene understanding outputs. These perception outputs can be used by the on-board system 110 to recognize and interpret the environment, which enables more accurate navigation and control decisions.

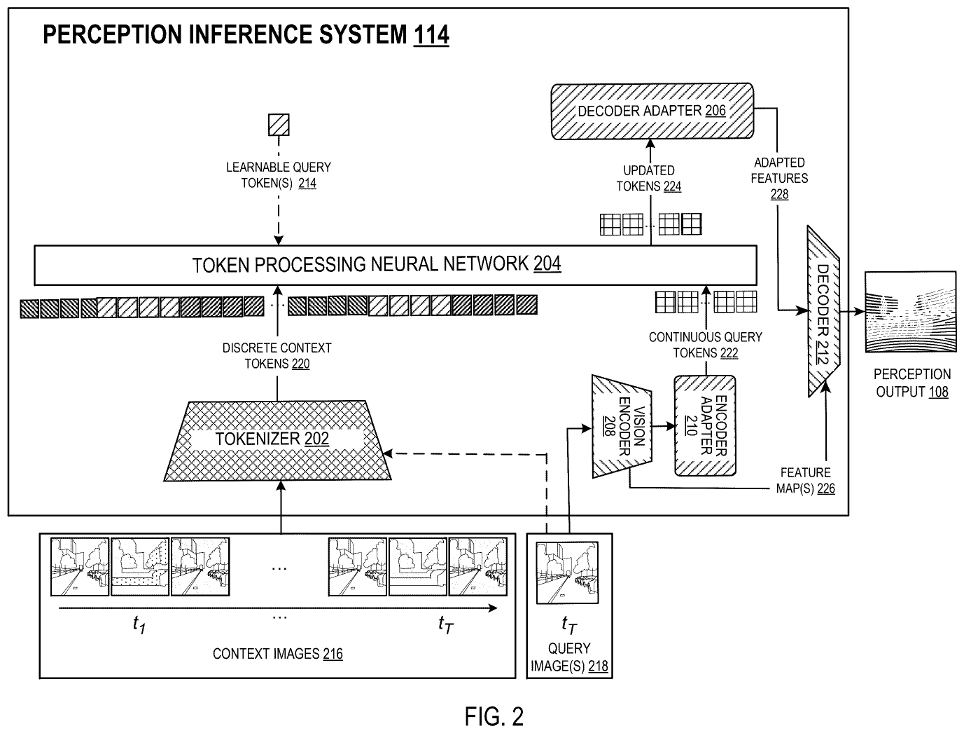

The processing performed by the perception inference system 114 to generate the perception output 108 is described in further detail below with reference to FIGS. 2-4.

The on-board system 110 can provide the perception output 108 generated by the perception inference system 114 to a planning system 116, a user interface system 118, or both.

When the planning system 116 receives the perception output 108, the planning system 116 can use the output to make fully-autonomous or partly-autonomous driving decisions. For example, the planning system 116 can generate a fully-autonomous plan to navigate the vehicle 120 based on depth estimation outputs, semantic segmentation masks, or object detection results that identify pedestrians, vehicles, or other obstacles in the roadway. In a particular example, the on-board system 110 may provide the planning system 116 with a perception output 108 indicating that a detected object ahead corresponds to a pedestrian stepping into the crosswalk. In this example, the planning system 116 can generate fully-autonomous control outputs to apply the brakes of the vehicle 120 to avoid a collision with the pedestrian. The fully-autonomous or partly-autonomous driving decisions generated by the planning system 116 can be implemented by a control system of the vehicle 120. For example, in response to receiving a fully-autonomous driving decision generated by the planning system 116 which indicates that the brakes of the vehicle should be applied, the control system may transmit an electronic signal to a braking control unit of the vehicle. In response to receiving the electronic signal, the braking control unit can mechanically apply the brakes of the vehicle.

When the user interface system 118 receives the perception output 108, the user interface system 118 can use the output to present information to the driver of the vehicle 120 to assist the driver in operating the vehicle safely. The user interface system 118 can present information to the driver of the vehicle 120 by any appropriate means, for example, by an audio message transmitted through a speaker system of the vehicle 120 or by alerts displayed on a visual display system in the vehicle (e.g., an LCD display on the dashboard of the vehicle 120). In a particular example, the on-board system 110 may provide the user interface system 118 with a perception output 108 indicating that an object detected in the vehicle's lane corresponds to a stalled vehicle. In this example, the user interface system 118 can present an alert message to the driver of the vehicle 120 with instructions to change lanes or slow down to avoid the obstacle.

Prior to the on-board system 110 using the perception inference system 114 to generate perception outputs, a training system 122 can generate trained parameter values by training a perception training system 138 on training data.

The training system 122 is typically hosted within a data center 124, which can be a distributed computing system having hundreds or thousands of computers in one or more locations.

The training system 122 can store the training data 134 in a training data store 130.

The training system 122 includes a perception training system 138 that is configured to generate training perception outputs 140 from training examples 132 using a token processing neural network. The token processing neural network of the perception training system 138 generally has (at least partially) the same architecture as the token processing neural network of the perception inference system 114.

The perception training system 138 is configured to obtain training examples 132 from the training data store 130. The training examples 132 can be a subset of the training data 134. The training examples 132 in the training data store 130 may be obtained from real or simulated driving data logs.

The training examples 132 can include data from multiple different modalities. In some cases, the context sensor data includes raw sensor outputs generated by one or more sensors, such as a camera sensor, a lidar sensor, or both. In other cases, the context sensor data includes structured outputs derived from the raw sensor data, such as depth maps, segmentation masks, or edge maps generated by a perception model (e.g., a depth estimation network or a segmentation model). The structured outputs can provide geometric or semantic context that complements the raw sensor data and enables the training system 122 to generate more accurate training perception outputs. The perception training system 138 can process the training examples 132 to generate a training perception output 140.

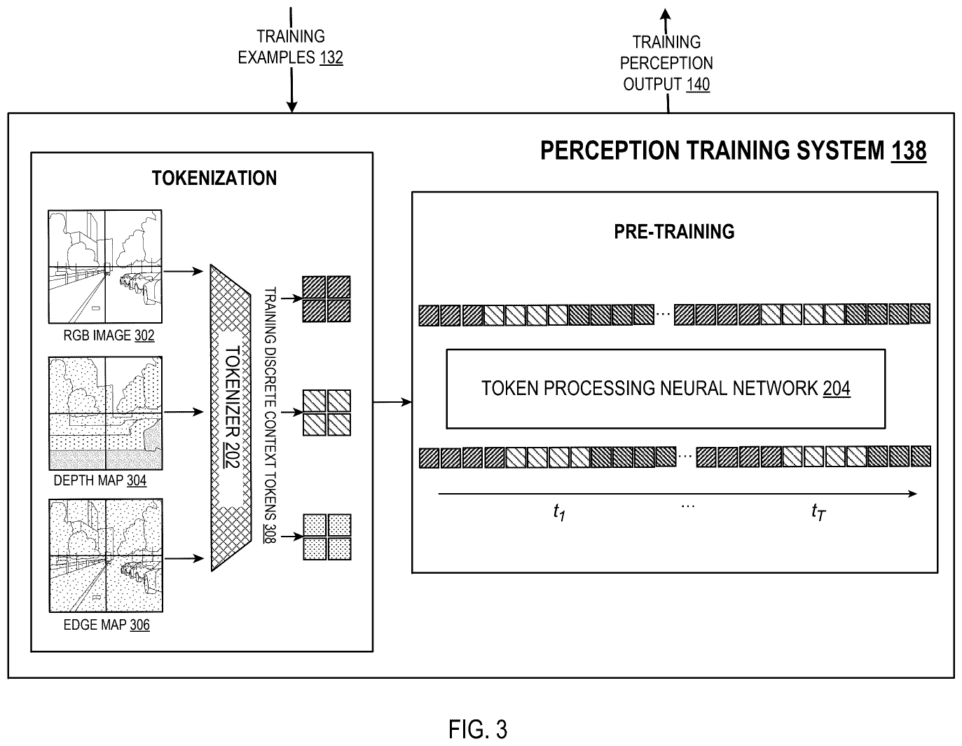

The training engine 142 then trains the perception training system 138 on the training examples 132 to generate updated model parameter values 144 by minimizing a loss function based on ground-truth labels for the perception tasks. For example, for a depth estimation perception task, the loss function can be based on ground-truth depth values derived from lidar point clouds, and for a semantic segmentation perception task, the loss function can be based on ground-truth segmentation masks, as described in further detail below with reference to FIG. 3.

Once the parameter values of the perception training system 138 have been fully trained, the training system 122 can send the trained parameter values 146 to the perception inference system 114, e.g., through a wired or wireless connection.

While this specification describes that the perception output 108 is generated on-board an autonomous vehicle, more generally, the described techniques can be implemented on any system of one or more computers that receives images of scenes in an environment. That is, once the training system 122 has trained the perception inference system 114, the trained neural network can be used by any system of one or more computers.

As one example, the perception output 108 can be generated on-board a different type of agent that has sensors and that interacts with objects as it navigates through an environment. For example, the perception output 108 can be generated by one or more computers embedded within a robot or other agent.

As another example, the perception output 108 can be generated by one or more computers that are remote from the agent and that receive images captured by one or more camera sensors of the agent. In some of these examples, the one or more computers can use the perception output 108 to generate control decisions for controlling the agent and then provide the control decisions to the agent for execution by the agent.

As another example, the perception output 108 can be generated in a computer simulation of a real-world environment being navigated by a simulated autonomous vehicle and simulated agents. In this case, the perception outputs can be used to evaluate a realism of the simulation, to test control software before deployment, to train machine learning models to be deployed on-board vehicles, or a combination thereof.

FIG. 2 is a block diagram of an example prediction system.

In general, the perception inference system 114 can obtain data characterizing a driving scene for multiple time points, and the perception inference system 114 can generate a perception output 108 using a token processing neural network 204.

The perception inference system 114 can obtain query sensor data 102 and context sensor data 106. The query sensor data 102 can include one or more query images 218 captured at a current time point (e.g., the most recent frame in a sequence), and the context sensor data 106 can include one or more context images 216 captured by camera sensors at one or more earlier time points relative to the current time point. The earlier time points can include immediately preceding time points (e.g., the last N frames) and/or selected prior time points based on a temporal window of the perception inference system 114. As such, the context sensor data 106 can provide a history of the scene that conditions interpretation of the current query images 218.

In some examples, the query sensor data 102 can include query radar data and the context sensor data 106 can include radar data captured at earlier time points. In another example, the query sensor data 102 can include query range images or point clouds, and the context sensor data 106 can include corresponding range images or point clouds captured by lidar sensors. In another example, the query sensor data 102 and the context sensor data 106 can include a combination of different sensor modalities, such as both camera and lidar data, which allows the system to leverage multiple sensing sources. The description that follows will generally describe the query sensor data 102 and context sensor data 106 as being image data. However, as described above, the described techniques can be applied to any appropriate type(s) of sensor data.

The tokenizer 202 can process the context images 216 to generate a sequence of discrete context tokens 220 representing the context images 216. For example, the tokenizer 202 can be a vector-quantization (VQ) based model, such as a ViT-VQGAN or a similar neural tokenizer. The tokenizer 202 can encode each image into a lower-dimensional latent feature map, and the tokenizer 202 can then quantize each feature vector by assigning the feature vector to a closest entry in a learned codebook. In particular, the index of the codebook entry can serve as the discrete token, which the system can store as a compact integer value for more efficient on-board storage. The tokens are referred to as discrete because each token is selected from a fixed vocabulary of tokens, i.e., a vocabulary that includes a fixed number of tokens. A token, as used in this specification, is a vector of numerical values, e.g., floating point values or other values.

This quantization procedure compresses the high-dimensional image data of the context images 216 into compact symbolic representations, which allows the system to represent large sequences of visual inputs efficiently. By using a fixed vocabulary of tokens (e.g., the codebook), the tokenizer 202 can ensure that the discrete context tokens 220 maintain consistency across different training and inference examples, which further enables the token processing neural network 204 to reason over temporal context in a uniform representation space.

In some examples, the tokenizer 202 can also process the one or more query images 218 to generate a sequence of discrete tokens representing the current image. In this case, the input to the token processing neural network 204 can include the discrete context tokens 220 representing the context images 216, the continuous query tokens 222 representing the query images 218, and the discrete tokens representing the query images 218. Because each discrete token can be represented compactly (e.g., as a single integer from a fixed vocabulary), storing only the discrete token representations of the context images allows the system to retain relatively long temporal sequences more efficiently, even with limited on-board memory resources.

In some examples, the system can generate one or more structured outputs by processing each context image 216 using a respective task neural network for the modality. For example, the system can use a depth prediction network to generate a depth map, a segmentation network to generate a segmentation mask or, in some implementations, an edge map derived from a segmentation mask to ensure consistent labeling, or an edge detection network to generate an edge map. The system can then process each structured output using the tokenizer 202 to generate corresponding discrete tokens. In some examples, the system can adapt the structured outputs into a format compatible with the tokenizer 202. For example, a depth map or edge map can be broadcast across three channels and normalized to a [0,1] range, such that the same tokenizer (e.g., a ViT-VQGAN tokenizer) can process both images (e.g., query images, context images, or both) and structured outputs. As such, the same tokenizer 202 can operate across modalities. In some other examples, the system can use a separate tokenizer for each structured output type. For example, the system can use tokenizer 202 pre-trained on images, another tokenizer pre-trained on depth maps, and another tokenizer trained on edge maps or segmentations masks, such that each tokenizer corresponds to a respective modality.

In some cases, the tokenization can be pre-computed for reuse across multiple training or inference iterations. For example, the system can process each context image, depth map, segmentation mask, or edge map using a vision tokenizer 202 to generate a corresponding sequence of discrete tokens. In particular, for offline datasets, the system can execute the tokenizer 202 once per frame and/or per modality to generate discrete token indices, and the system can persist the discrete token indices as compact integer arrays based on a sequence ID, timestamp, and/or modality. The system can also store metadata (e.g., sensor ID, tokenizer/codebook version, normalization parameters, etc.) in a cache to enable subsequent validation. During training or inference, the system can retrieve the cached indices directly to avoid re-tokenizing the raw sensor data. For on-board real-time inference, the system can incrementally generate tokens for received images and maintain a fixed-size ring buffer of the last N context images. In some examples, if the tokenizer 202 is updated or if validation of the cached data fails, the system can invalidate the corresponding entries and regenerate the affected tokens.

The discrete tokens can then be included in the sequence of discrete context tokens 220 representing the context images 216.

In some examples, the task neural network can be a pretrained foundation model, such as Depth Anything or Segment Anything. To ensure a consistent label representation, the system can replace segmentation masks with edge maps when the ordering of segmentation masks is permutation-invariant. The system can also normalize values of the structured outputs, (e.g., scaling values to [0,1]), before tokenization.

The vision encoder 208 can process the one or more query images 218 to generate encoded feature maps 226. A feature map 226 can be a structured set of numerical values that represent visual characteristics of an image at different spatial locations. The vision encoder 208 can include any suitable convolutional or transformer-based backbone architecture, and in some examples, the vision encoder 208 can be a pretrained neural network configured to extract features for downstream adaptation. In particular, the vision encoder 208 can extract multi-scale feature maps 226 that capture both fine-grained visual data, such as edges and textures, and higher-level semantic data, such as object shapes or regions. The perception inference system 114 can then encode the feature maps 226 into continuous embeddings, which are numerical vector representations that preserve spatial and semantic detail from the query image 218.

The encoder adapter 210 can convert the feature maps 226 into continuous query tokens 222. Each continuous query token 222 represents a dense embedding that preserves detailed spatial and semantic information from the query images 218. In particular, the encoder adapter 210 can align the continuous embeddings generated by the vision encoder 208 with the feature space of the discrete context tokens 220 generated by the tokenizer 202. The encoder adapter 210 can resize and project the continuous embeddings into a continuous token format that is compatible with the token processing neural network 204. Unlike the discrete context tokens 220, which are constrained to be selected from a fixed vocabulary of codebook entries, the continuous query tokens 222 are not restricted to a finite set of values. That is, each value in a continuous query token embedding can take any value within the numerical system implemented by the token processing neural network 204 (e.g., floating-point values), which allows the tokens to encode fine-grained information. By combining the continuous embeddings of the query images with the discrete context tokens 220 representing the context images, the encoder adapter 210 allows the system to integrate scene-specific information with the continuous query tokens 222 as compact and temporally rich representations.

The perception inference system 114 can then process the sequence of discrete context tokens 220 representing the context images 216 and the one or more continuous query tokens 222 representing the query images 218 using the token processing neural network 204 to generate one or more updated continuous tokens (e.g., updated tokens 224) representing the one or more query images 218. That is, the system uses the token processing neural network 204 to update the continuous query tokens 222 while using the discrete context tokens 220 as context, and the system can then process the updated tokens 224 to generate the perception output 108.

The token processing neural network 204 can have any appropriate neural network architecture that allows the network to update the continuous query tokens 222 representing the query images 218 using the discrete context tokens 220 representing the context images 216. Each updated continuous token 224 can include scene-level information for a perception task, such as depth estimation, semantic segmentation, or object detection. The token processing neural network 204 can be an auto-regressive neural network. For example, the token processing neural network 204 can process batches of discrete context tokens 220 and continuous query tokens 222 in parallel to generate updated continuous tokens 224 for multiple frames, multiple modalities, or both.

In particular, the token processing neural network 204 can be a transformer-based self-attention neural network that includes one or more causal self-attention layers. During pre-training the token processing neural network can perform causal self-attention masking such that, when updating the continuous query tokens 222, each token attends only to the discrete context tokens 220 corresponding to the same or earlier time points in the temporal sequence, which ensures that the token processing neural network 204 does not use information from future frames when generating updated continuous tokens 224. During inference, however, the token processing neural network 204 can operate on the full set of prefix embeddings query tokens without performing token processing prediction.

In some examples, the token processing neural network 204 can also obtain one or more learnable query tokens 214, where the learnable query tokens 214 include a respective set of one or more learnable query tokens for each of one or more prediction tasks. In this case, the system can process the learnable query tokens 214 along with the discrete context tokens 220 and the continuous query tokens 222. The token processing neural network 204 can map the discrete context tokens 220 into continuous embeddings using an embedding layer, and then the token processing neural network 204 can process the embeddings, the continuous query tokens 222, and the learnable query tokens 214 together using one or more continuous token updating layers (e.g., causal self-attention layers). The learnable query tokens 214 can be learned queries that specialize the network outputs for particular perception tasks, which the perception inference system 114 can learn during training, as described in further detail below with reference to FIG. 3.

In some examples, the token processing neural network 204 can include an embedding layer that processes each discrete context token 220 to generate a corresponding continuous embedding, and one or more continuous token updating layers (e.g., transformer self-attention layers). That is, the embedding layer can map the discrete context tokens 220 into continuous embeddings, and the continuous token updating layers can process the embeddings together with the continuous query tokens 222 to generate the updated tokens 224 representing the query images 218, as shown in Equation 1 below:

$${\{ {\hat{q}}_{i} \}}_{i = 1}^{L} = Transformer ( [ ϕ ( {\{ {I}_{t}^{i} , {D}_{t}^{i} , {E}_{t}^{i} \}}_{t = 1}^{T} ) , {Q}_{task} , {\{ {\hat{q}}_{i} \}}_{i = 1}^{L} ] ) \qquad ( 1 )$$

$$where {\{ {\hat{q}}_{i} \}}_{i = 1}^{L}$$

are the updated tokens 224 generated by the token processing neural network 204, φ is an embedding layer that processes each of the discrete context tokens 220 to generate a corresponding continuous embedding, and

$${I}_{t}^{i} , {D}_{t}^{i} , and {E}_{t}^{i}$$

are the discrete tokens for the image, depth map, and edge map modalities for each of the multiple time steps t=1, . . . , T, as described in further detail with reference to FIG. 3. Together, these discrete tokens form a prefix sequence that provides temporal and multi-modal context to the token processing neural network 204. Qₜₐₛₖ is a learnable query token 214 that conditions the token processing neural network 204 on a particular perception task, and

$${\{ {\hat{q}}_{i} \}}_{i = 1}^{L}$$

are the continuous query tokens 222 representing the one or more query images 218. As shown in Equation 1, the token processing neural network 214 can process the prefix embeddings derived from the discrete context tokens 220 (including the

$${I}_{t}^{i} , {D}_{t}^{i} , and {E}_{t}^{i}$$

tokens), the learnable query token 214, and the continuous query tokens 222 to generate the updated tokens 224.

In some examples, the token processing neural network 204 can include causal self-attention layers, which, during pre-training, enforce that each query token 222 attends only to discrete context tokens 220 from the same or earlier time points. During inference, however, the token processing neural network 204 can process the discrete context tokens 220 and the continuous query tokens 222 jointly without performing auto-regressive prediction.

The decoder adapter 206 can process the updated tokens 224 generated by the token processing neural network 204 to generate the adapted features 228. In particular, the decoder adapter 206 can align the updated tokens 224 with the feature map(s) 226 generated by the vision encoder 208 to produce adapted features 228. By combining the updated tokens 224 with the feature map(s) 226, the decoder adapter 206 enables the decoder 212 to leverage both temporal context from the discrete context tokens 220 and detailed spatial structure from the query image(s) 218, as shown in Equation 2 below:

$${\hat{F}}_{i} = DecoderAdapter ( Concat ( {F}_{i} , Bilinear ( \hat{Q} ) ) ) , ∀ i = 1 , … , N \qquad ( 2 )$$

where \hat{F}ᵢ are the adapted features 228, and Fᵢ are the multi-scale feature maps 226 generated by the vision encoder 208. The index i represents a feature scale i=1, . . . , N corresponding to one of multiple different spatial resolutions generated by the vision encoder 208, such as a high-resolution feature map that preserves fine spatial detail or a low-resolution feature map that captures high-level semantic structure. The operation Bilinear (\hat{Q}) represents the resizing of the updated tokens 224 using bilinear interpolation, such that the spatial dimensions of \hat{Q} match (e.g., are equal to) the spatial dimensions of the corresponding feature map Fᵢ. The decoder adapter 206 concatenates Fᵢ with Bilinear (\hat{Q}) to generate a fused feature representation that combines the local spatial detail of the encoder features with the scene-level context from the updated tokens 224. In some examples, the decoder adapter 206 can be a lightweight convolutional neural network (e.g., a small stack of convolutional layers) that projects and refines the fused feature representation into the adapted feature space. The decoder adapter 206 then processes the concatenated features using one or more convolutional layers to generate the adapted features \hat{F}ᵢ. The system can then provide the adapted features 228 to the decoder 212.

The decoder 212 can then process the adapted features 228 from the decoder adapter 206 to generate task-specific outputs. The decoder 212 can be a neural network (e.g., a convolutional neural network) configured to map feature representations into structured predictions for a given perception task. In some examples, the decoder 212 can be a pre-trained decoder that generates outputs for multiple tasks. In some examples, the decoder 212 can be a vision transformer. In some other examples, the perception inference system 114 can include multiple different task-specific decoders 212, where each decoder 212 is configured to generate outputs for a particular perception task, such as semantic segmentation, depth estimation, or object detection.

The perception output 108 can include outputs for one or more perception tasks. The one or more prediction tasks can generally include any appropriate perception tasks. For example, the prediction tasks can include any one or more of object detection, instance segmentation, semantic segmentation, panoptic segmentation, depth prediction, surface normal prediction, optical flow prediction, object recognition, and so on.

The perception output 108 can represent a structured inference of the system about the driving scene, such as a depth map indicating the relative distances of scene elements, a segmentation mask assigning semantic categories to each pixel, bounding boxes for detected objects, or optical flow vectors indicating motion between frames.

The system can then use these perception outputs 108 to provide scene understanding in real time on-board an autonomous vehicle, to generate labeled data in a simulated environment, or both. Thus, by generating the perception outputs, the system enables downstream components such as planning and control modules to make navigation decisions based on a more accurate understanding of the surrounding environment.

The perception output 108 represents a structured inference of the system about the driving scene, such as a depth map indicating the relative distances of scene elements, a segmentation mask assigning semantic categories to each pixel, bounding boxes for detected objects, or optical flow vectors indicating motion between frames. The system can generate the perception outputs 108 on-board an autonomous vehicle in real time to provide scene understanding for navigation through the environment. In this case, the on-board system can use the perception outputs 108 to support downstream planning and control components that plan the future motion of the vehicle based on the detected road layout, obstacles, other agents in the environment, or a combination thereof.

The system can also generate the perception outputs 108 in a computer simulation of a real-world environment being navigated by a simulated autonomous vehicle and simulated agents. In this case, the system can use the perception outputs 108 in controlling the simulated vehicle, which ensures that the simulation includes complex or surprising interactions likely to occur in real-world driving. More generally, generating perception outputs 108 in simulation can form part of testing the control software of a real-world autonomous vehicle before deployment, training one or more machine learning models that will later be deployed on-board, or both.

FIG. 3 is a block diagram of another example training prediction system.

In general, the perception training system 138 can train the token processing neural network 204 to generate training perception outputs 140 using the training examples 132 by performing tokenization and pre-training. The perception training system 138 can obtain training examples 132 from a training data store 130. The training examples 132 can include raw sensor data, such as camera images (e.g., RGB images 302), lidar range images, radar measurements, or structured outputs derived from such data, such as depth maps 304 or edge maps 306.

During tokenization, the perception training system 138 can process the training examples 132 to generate training discrete context tokens 308. In particular, the tokenizer 202 can process each training example 132 to generate a sequence of training discrete context tokens 308 representing the training examples. The tokenizer 202 can select each discrete token from a fixed vocabulary of tokens, where each token is a vector of numerical values that provides a compact symbolic representation of the high-dimensional input. By using a fixed vocabulary, the tokenizer 202 ensures that the training discrete context tokens 308 maintain consistency across diverse training examples, which enables the token processing neural network 204 to learn temporal and semantic relationships across different modalities.

In some examples, the system can generate structured outputs for the training examples 132 by processing the RGB image 302 using a task neural network for the modality. For example, the system can use a depth prediction network to generate the depth map 304, or a segmentation network to generate segmentation masks, which can then be converted into an edge map 306 to ensure consistent labeling. The edge maps can provide a binary mask of edge regions, which avoids the permutation invariance issue that arises with segmentation masks. In some cases, the task neural network can be a pretrained model, such as Depth Anything or Segment Anything, as described above. In addition to generating the depth map 304 and edge map 306, the RGB image 302 itself can also be tokenized directly to generate discrete tokens, such that the training discrete context tokens 308 represent all three modalities (e.g., image, depth, and edge).

During pre-training, the system can provide the sequences of training discrete context tokens 308 to the token processing neural network 204. In particular, the token processing neural network 204 can be trained on a next-token prediction task, in which the token processing neural network 204 predicts the next discrete token in the sequence given the preceding tokens. Importantly, the token processing neural network 204 can employ causal self-attention masking so that each token attends only to tokens from the same or earlier positions in the sequence. This causal structure ensures that the network does not use privileged information from future tokens when performing next-token prediction.

The training perception output 140 can represent the predicted next tokens. The training engine 142 can then update the model parameters 128 of the token processing neural network 204 by comparing the predicted next tokens against the ground-truth tokens. In particular, the training engine 142 can minimize a cross-entropy loss (e.g., negative log-likelihood) between the predicted probability distribution over the vocabulary and the ground-truth discrete tokens, and the training engine 142 can update the model parameters of the token processing neural network 204 based on the loss, such that the system can train the token processing neural network 204 to perform next-token prediction in a causal manner. In some examples, during fine-tuning on downstream perception tasks, the training engine 142 can use one or more task-specific supervised loss functions, such as an L1 loss for depth estimation or a focal cross-entropy loss for semantic segmentation.

In some examples, after pre-training, the system can perform supervised fine-tuning to adapt the pre-trained model to one or more specific perception tasks. In particular, the training engine 142 can train the vision encoder 208, encoder adapter 210, decoder adapter 206, and one or more task neural networks using labeled training data for respective perception tasks, such as ground-truth depth values from lidar point clouds or ground truth segmentation masks.

In some examples, the training engine 142 can also fine-tune the token processing neural network 204 jointly with one or more of: the vision encoder 208, encoder adapter 210, decoder adapter 206, and the decoder 212, which ensures that each of the components of the perception inference system 114 operate together to produce high-quality perception outputs 108 across multiple tasks.

Thus, the perception training system 138 can leverage both large-scale unsupervised pre-training based on next-token prediction and task-specific supervised fine-tuning, which can result in a trained model that generalizes effectively to diverse perception tasks required in real-world and simulated autonomous driving environments.

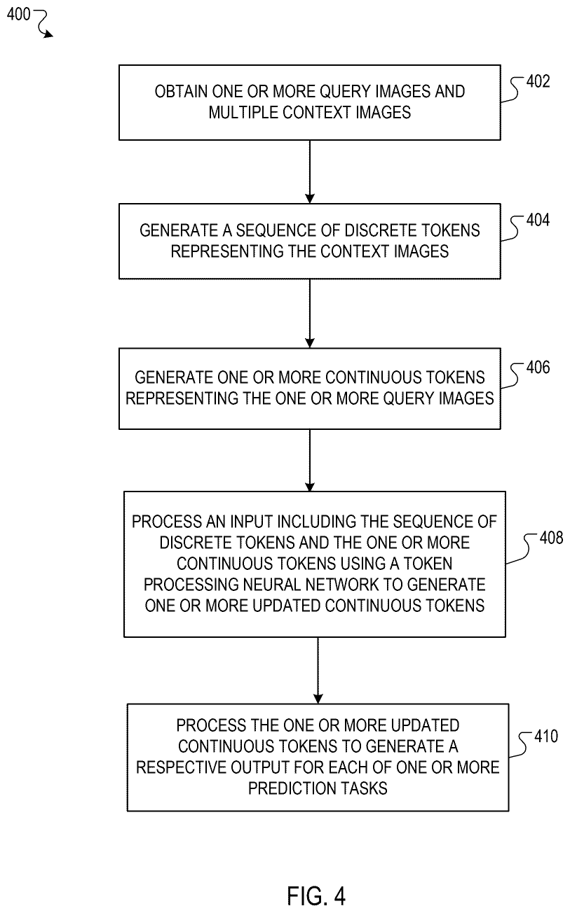

FIG. 4 is a flow diagram of an example process for performing perception tasks on received sensor data. For convenience, the process 400 will be described as being performed by a system of one or more computers located in one or more locations. For example, a system, e.g., the system 100 of FIG. 1, appropriately programmed in accordance with this specification, can perform the process 400.

The system can obtain one or more query images and multiple context images (402). The one or more query images can be captured by a set of one or more cameras at a current time point, and the context images can include a respective set of one or more context images captured by the set of one or more cameras at each of one or more preceding time points.

The system can generate a sequence of discrete tokens representing the context images (404). In particular, for each context image, the system can process the context image using a vision tokenizer neural network to generate one or more discrete tokens, and the system can include the one or more discrete tokens in the sequence of discrete tokens representing the context images.

In some examples, for each context image and for each of one or more modalities, the system can generate a respective structured output for the context image for the modality. The one or more modalities can include a depth prediction modality, a segmentation modality, or both. The system can then process the respective structured output using the vision tokenizer neural network to generate one or more discrete tokens, and the system can include the one or more discrete tokens in the sequence of discrete tokens representing the context images.

The system can generate one or more continuous tokens representing the one or more query tokens representing the one or more query images (406). In particular, the system can process the one or more query images using an image encoder neural network to generate an encoded feature map representing the one or more query images, and the system can process the encoded feature map using an encoder adapter neural network to generate the one or more continuous tokens. In some examples, the system can process the context image using a task neural network for the modality to generate the respective structured output for the modality.

The system can process an input including the sequence of discrete tokens and the one or more continuous tokens using a token processing neural network to generate one or more updated continuous tokens (408). The one or more updated continuous tokens represent the one or more query images. In some examples, the system can generate a sequence of discrete tokens representing the current image, and the input including the sequence of discrete tokens and the one or more continuous tokens can also include the sequence of discrete tokens representing the current image.

In some examples, the sequence of discrete tokens representing the context images and the one or more continuous tokens can also include one or more learnable query tokens. The learnable query tokens can include a respective set of one or more learnable query tokens for each of the one or more prediction tasks.

In some examples, the token processing neural network is a transformer neural network. In some examples, the token processing neural network includes one or more causal self-attention layers.

In some examples, the token processing neural network includes (i) an embedding layer and (ii) one or more continuous token updating layers. In this case, the system can process each discrete token in the input using the embedding layer to generate a continuous token representing the discrete token, and the system can process at least the continuous tokens representing the discrete tokens and the continuous tokens representing the one or more query images using the continuous token updating layers to generate the one or more updated continuous tokens representing the one or more query images.

The system can process the one or more updated continuous tokens to generate a respective output for each of one or more prediction tasks (410). In particular, the system can process the one or more updated continuous tokens by generating, from the updated continuous tokens, an adapted feature representing the one or more query images. For example, the system can process an input including the updated continuous tokens using a decoder adapter neural network to generate the updated feature.

For each of the one or more prediction tasks, the system can process the adapted feature representing the one or more query images using a decoder neural network for the prediction task to generate the output for the prediction task.

In some examples, the token processing neural network has been pre-trained on a next token prediction task that includes predicting, given a current sequence of discrete tokens, a next discrete token that follows a last discrete token in the current sequence of discrete tokens. After pre-training, the image encoder, the encoder adapter, the decoder adapter, and the decoder neural networks for the prediction tasks have been trained through supervised learning on labeled training data for the one or more prediction tasks. In some examples, the token processing neural network is fine-tuned during the training through supervised learning.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data The data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
obtaining one or more query images and a plurality of context images;
generating a sequence of discrete tokens representing the context images;
generating one or more continuous tokens representing the one or more query images;
processing an input comprising the sequence of discrete tokens representing the context images and the one or more continuous tokens representing the one or more query images using a token processing neural network to generate one or more updated continuous tokens representing the one or more query images; and
processing the one or more updated continuous tokens to generate a respective output for each of one or more prediction tasks.

2. The method of claim 1, wherein processing the one or more updated continuous tokens to generate a respective output for each of one or more prediction tasks comprises:
generating, from the updated continuous tokens, an adapted feature representing the one or more query images; and
for each of the one or more prediction tasks, processing the adapted feature representing the one or more query images using a decoder neural network for the prediction task to generate the output for the prediction task.

3. The method of claim 2, wherein generating, from the updated continuous tokens, an adapted feature representing the one or more query images comprises:
processing an input comprising the updated continuous tokens using a decoder adapter neural network to generate the adapted feature.

4. The method of claim 1, wherein generating one or more continuous tokens representing the one or more query images comprises:
processing the one or more query images using an image encoder neural network to generate an encoded feature map representing the one or more query images; and
processing the encoded feature map using an encoder adapter neural network to generate the one or more continuous tokens.

5. The method of claim 1, further comprising:
generating a sequence of discrete tokens representing the current image; and
wherein the input comprising the sequence of discrete tokens representing the context images and the one or more continuous tokens further comprises the sequence of discrete tokens representing the current image.

6. The method of claim 1, wherein the input comprising the sequence of discrete tokens representing the context images and the one or more continuous tokens further comprises one or more learnable query tokens.

7. The method of claim 6, wherein the learnable query tokens comprise a respective set of one or more learnable query tokens for each of the one or more prediction tasks.

8. The method of claim 1, wherein the token processing neural network is a transformer neural network.

9. The method of claim 1, wherein the token processing neural network comprises one or more causal self-attention layers.

10. The method of claim 1, wherein generating a sequence of discrete tokens representing the context images comprises, for each context image:
processing the context image using a vision tokenizer neural network to generate one or more discrete tokens; and
including the one or more discrete tokens in the sequence of discrete tokens representing the context images.

11. The method of claim 10, wherein generating a sequence of discrete tokens representing the context images comprises, for each context image and for each of one or more modalities:
generating a respective structured output for the context image for the modality;
processing the respective structured output using the vision tokenizer neural network to generate one or more discrete tokens; and
including the one or more discrete tokens in the sequence of discrete tokens representing the context images.

12. The method of claim 11, wherein the one or more modalities include a depth prediction modality.

13. The method of claim 11, wherein the one or more modalities include a segmentation modality.

14. The method of claim 11, wherein generating a respective structured output for the context image for the modality comprises:
processing the context image using a task neural network for the modality to generate the respective structured output for the modality.

15. The method of claim 1, wherein the token processing neural network comprises (i) an embedding layer and (ii) one or more continuous token updating layers, and wherein processing an input comprising the sequence of discrete tokens representing the context images and the one or more continuous tokens representing the one or more query images using a token processing neural network to generate one or more updated continuous tokens representing the one or more query images comprises:
processing each discrete token in the input using the embedding layer to generate a continuous token representing the discrete token; and
processing at least the continuous tokens representing the discrete tokens and the continuous tokens representing the one or more query images using the continuous token updating layers to generate the one or more updated continuous tokens representing the one or more query images.

16. The method of claim 1, wherein the one or more query images are captured by a set of one or more cameras at a current time point and wherein the context images comprise a respective set of one or more context images captured by the set of one or more cameras at each of one or more preceding time points.

17. The method of claim 1, wherein the token processing neural network has been pre-trained on a next token prediction task that requires predicting, given a current sequence of discrete tokens, a next discrete token that follows a last discrete token in the current sequence of discrete tokens.

18. The method of claim 17, wherein, after the pre-training, the image encoder, the encoder adapter, the decoder adapter, and the decoder neural networks for the prediction tasks have been trained through supervised learning on labeled training data for the one or more prediction tasks.

19. The method of claim 18, wherein the token processing neural network is fine-tuned during the training through supervised learning.

20. A system comprising:
one or more computers; and
one or more storage devices storing instructions that, when executed by the one or more computers, cause the one or more computers to perform the respective operations comprising:
obtaining one or more query images and a plurality of context images;
generating a sequence of discrete tokens representing the context images;
generating one or more continuous tokens representing the one or more query images;
processing an input comprising the sequence of discrete tokens representing the context images and the one or more continuous tokens representing the one or more query images using a token processing neural network to generate one or more updated continuous tokens representing the one or more query images; and
processing the one or more updated continuous tokens to generate a respective output for each of one or more prediction tasks.

21. One or more computer-readable storage media storing instructions that when executed by one or more computers cause the one or more computers to perform operations comprising:
obtaining one or more query images and a plurality of context images;
generating a sequence of discrete tokens representing the context images;
generating one or more continuous tokens representing the one or more query images;
processing an input comprising the sequence of discrete tokens representing the context images and the one or more continuous tokens representing the one or more query images using a token processing neural network to generate one or more updated continuous tokens representing the one or more query images; and
processing the one or more updated continuous tokens to generate a respective output for each of one or more prediction tasks.
